(19) United States
(12) Patent Application Publication
(10) Pub. No.: US 2024/0421936 A1
(43) Pub. Date: Dec. 19, 2024

(54) ADAPTIVE FORWARD ERROR CORRECTION

(71) Applicant: ESpace Networks, Inc., Dover, DE (US)

(72) Inventors: Prateek Dahale, Maharashtra (IN); Raghuraman Jaganaathan, Cumming, GA (US)

(21) Appl. No.: 18/744,255

(22) Filed: Jun. 14, 2024

Related U.S. Application Data
(60) Provisional application No. 63/521,014, filed on Jun. 14, 2023.

(51) Int. Cl. H04L 1/00; H04L 1/08

(52) U.S. Cl. CPC H04L 1/0061; H04L 1/08

(57) ABSTRACT

The disclosed communication system includes a Dynamic Multiple Input/Multiple Output Transmission System (DMTS) module, and an adaptive forward error correction (FEC) module. The FEC module includes a transmission module for receiving first packets and commands from the DMTS module, generating a parity check for n number of the first packets, and retransmitting the first packets with the parity check to a channel manager in a transmission direction. The FEC module also includes a receive module for receiving second packets from the channel manager in a receive direction. The DMTS controls when a parity check is sent for a given flow. The parity check may be sent across multiple channels, and the FEC module can be enabled or disabled for each traffic flow.

### CROSS REFERENCE TO RELATED APPLICATIONS

This application claims priority to U.S. Provisional Patent Application No. 63/521,014, filed on Jun. 14, 2023, the entire contents of which are hereby incorporated by reference.

### FIELD OF THE INVENTION

Embodiments of the present invention generally relate to a system and method for implementing forward error correction coding, in particular, adaptive forward error correction (“FEC”).

### BACKGROUND

FEC generally refers to techniques of controlling and correcting errors in data transmission by sending redundant or retransmitted data in anticipation of this data being dropped during transit. This redundant data can include error-corrective coding, such as verification information. In implementing known FEC techniques, FEC frames are generally used to regenerate frames on the receiving end to avoid the need to have the data retransmitted. A FEC frame is manually configured to be sent after every ‘n’ data frames. The manual configuration does not account for ever changing communications link conditions.

Data Packets are sent between Hub and Spoke, which is the datapath. The Spoke sits on some remote device that is moving, such as a ship or airplane, while a Hub that is in a stationary data center. The path between the Hub and Spoke can be comprised of multiple LEO/MEO/GEO/Starlink satellite links with very dynamic link conditions. Thus, for a given customer data (i.e., browsing or streaming or video calls), levels of priority are assigned to traffic classes, and based on the link conditions, the customer data with the highest priority traffic class is sent on the best link.

Given the dynamic link conditions due to the movement of the Spoke and weather conditions, there is a need in the art for an improved method and system for data communications. Adaptive FEC, sometimes referred to in the art as AFEC, is a studied improvement to FEC whereby the system flexibly adjusts the transmission of redundant data packets in response to changing data packet loss rate on the receiving end. As an increase in data packet loss is detected, the system can increase the rate at which redundant data packets are transmitted in accordance with known FEC techniques.

### SUMMARY

The following presents a simplified summary of the disclosure in order to provide a basic understanding of some aspects of the disclosure. This summary is not an extensive overview of the disclosure. It is not intended to identify key, or critical, elements of the disclosure or delineate the scope of the disclosure. Its sole purpose is to present some concepts of the disclosure in a simplified form as a prelude to the more detailed description that is presented later.

Disclosed is a method and system for implementing adaptive FEC in a communications network. The relevant portions of the communications network may include a channel, a channel manager, an FEC engine, a Dynamic Multiple Input/Multiple Output Transmission System (“DMTS”) and a drop side. The DMTS is a decision-based engine that may be used to decide what link to send a packet over.

In one embodiment, the FEC layer lies between the DMTS and the channel manager. The DMTS engine controls when a FEC parity packet is sent for a given traffic flow. The FEC parity packet may be sent across multiple channels and the FEC can be enabled/disabled for each traffic flow. If FEC is disabled for a given traffic flow, all packets for that flow arriving from the DMTS engine are just forwarded to the channel manager without any FEC management.

The following description and drawings set forth in detail certain illustrative aspects of the disclosure. These aspects are indicative, however, of but a few of the various ways in which the principles of the disclosed system and method may be employed and the present disclosure is intended to include all such aspects and their equivalents. Other advantages and novel features of the disclosed system and method will become apparent from the following description of the subject matter disclosed herein when considered in conjunction with the drawings.

### BRIEF DESCRIPTION OF THE DRAWINGS

FIG. 1 illustrates one embodiment of the disclosed system which includes a DMTS engine, an FEC engine, and a channel manager.

FIG. 2A illustrates an FEC layer shown with data flowing in the transmission direction in accordance with one embodiment.

FIG. 2B illustrates an FEC layer shown with data flowing in the receiving direction in accordance with one embodiment.

FIG. 3 illustrates an exemplary 32-bit superframe in accordance with one embodiment.

FIG. 4 illustrates an exemplary superframe pool for a remote grid ID and a flow ID in accordance with one embodiment.

FIG. 5 illustrates the FEC engine maintaining a superframe pool for each unique superframe ID in accordance with one embodiment.

FIG. 6 illustrates a superframe pool being accessed through a hash table in accordance with one embodiment.

FIG. 7 illustrates information contained in a superframe pool in accordance with one embodiment.

FIG. 8 illustrates the arrival, in sequence, of three subframes and a parity frame corresponding to a superframe in accordance with one embodiment of the disclosed processing system.

FIG. 9A illustrates one implementation of a processing system where a subframe arrives late and is discarded and not sent to DMTS in accordance with one embodiment.

FIG. 9B illustrates one implementation of a processing system where a subframe never arrives, a frame is regenerated by the FEC, and sent to DMTS in accordance with one embodiment.

FIG. 10A illustrates one implementation of a processing system where a parity frame for a superframe arrives before the last two subframes arrive in accordance with one embodiment.

FIG. 10B illustrates one implementation of a processing system where the system discards a third subframe if it arrives late in accordance with one embodiment.

FIG. 11 illustrates one implementation of a processing system where a parity frame for a superframe is never received in accordance with one embodiment.

FIG. 12A illustrates one implementation of a processing system where more than one subframe is lost or one subframe and also a parity frame is lost in accordance with a first embodiment.

FIG. 12B illustrates one implementation of a processing system where more than one subframe is lost or one subframe and also a parity frame is lost in accordance with a second embodiment.

FIG. 12C illustrates one implementation of a processing system where more than one subframe is lost or one subframe and also a parity frame is lost in accordance with a third embodiment.

FIG. 13A illustrates the relationship between FEC level (x-axis) and consumed bandwidth (y-axis) after implementing forward error correction in accordance with one embodiment.

FIG. 13B illustrates the relationship between FEC level (x-axis) and packet loss (y-axis) after implementing forward error correction in accordance with one embodiment.

### DETAILED DESCRIPTION

The following detailed description and the appended drawings describe and illustrate some embodiments for the purpose of enabling one of ordinary skill in the relevant art to make use of the invention. As such, the detailed description and illustration of these embodiments are purely illustrative in nature and are in no way intended to limit the scope of the invention, or its protection, in any manner. It should also be understood that the drawings are not necessarily to scale and in certain instances details may have been omitted, which are not necessary for an understanding of the disclosure, such as details of fabrication and assembly. In the accompanying drawings, like numerals represent like components.

Disclosed is a communication system that includes a DMTS module, and an adaptive FEC module. The adaptive FEC module includes a transmission module for receiving first packets and commands from the DMTS module, generating a parity check for n number of the first packets, and retransmitting the first packets with the parity check to a channel manager in a transmission direction.

The adaptive FEC module also includes a receive module for receiving second packets from the channel manager in a receive direction. The DMTS controls when a parity check is sent for a traffic flow; the parity check may be sent across multiple channels; and the FEC module can be enabled or disabled for each traffic flow.

In the disclosed communication system, the channel manager switches between subchannels between the FEC module and a channel side; the channel manager determines link conditions for a link, including packet loss, latency and jitter; and the channel manager further determines when the link goes online or offline.

In the disclosed communication system, the DMTS module selects a transmission link to utilize in transmitting a data packet, and controls the enabling or disabling of the FEC module, including when to generate and send the parity check at any time in a given channel flow.

In the disclosed communication system, the DMTS operates in a transmission direction to determine for a given traffic, based on traffic priority, jitter, latency, packet loss, bandwidth cost, or demand, from a number of available links, which is the best link to send data packets, how often a parity check is to be sent by the transmission module of the FEC module, and the number of N packets for which the parity check is generated.

In the disclosed communication system, the receive module of the FEC module receives the second data packets, the second data packets including a parity check, and processes the second data packets to regenerate any lost packets.

In one embodiment of the disclosed communication system, the receive module regenerates one lost data packet. In another embodiment the receive module does not regenerate any lost data packets when more than one data packet is lost.

In the disclosed communication system, the first data packets may be transmitted in the transmission direction through the transmission module of the FEC module, and the transmission module assigns one or more of the first data packets to a superframe pool having a plurality of subframes. The subframes are XOR'ed to generate one parity frame for each superframe pool.

In one embodiment the parity check is added as a subframe to the superframe pool and the subframes may be sent across to a channel side through the channel manager and the parity check subframe is sent as the last subframe frame after all subframes are sent.

In one embodiment the second data packets may be received by the receive module of the FEC module as subframes arriving from the channel manager, are transformed to packets, and sent to the DMTS module. The receive module of the FEC module may store a copy of each subframe in a buffer pool for each superframe pool and the parity check is used to generate any lost subframe. In one embodiment, after all received subframes are processed by the receive module of the FEC module, pools are deleted and the superframe pool is freed.

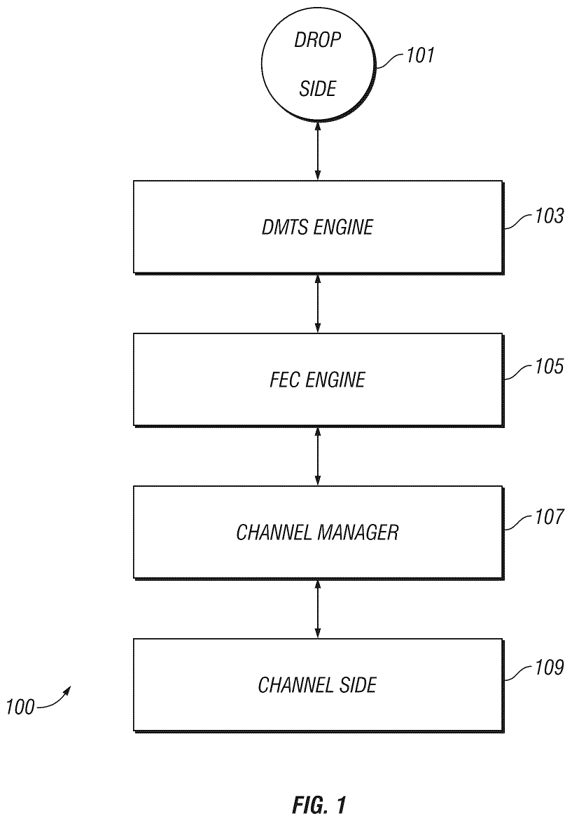

Referring to FIG. 1, in one embodiment the system 100 of the present invention may include a data or network channel for the bi-directional data transfer between a drop side 101 (e.g., a connection point to a LAN associated with the Spoke) and a channel side 109, and the channel may include one or more data transmission engines including a channel manager 107, an FEC engine 105, and a DMTS engine 103. The channel may be a data transmission path over a specified WAN circuit (i.e. WiFi, Starlink, 5G, SCPC, TDMA, etc.), and may simultaneously accommodate data transmission for thousands of users. Data transmitted from the drop side 101 to the channel side 109 may be referred to herein as the transmission (Tx) direction while data transmitted from the channel side 109 to the drop side 101 may be referred to herein as the receiving (Rx) direction. The channel manager 107 may be operable to switch subchannels between the FEC Engine 105 and the channel side 109. In one embodiment, the channel manager 107 manages multiple LEO/MEO/GEO/Starlink satellite links. It determines the link conditions like packet loss, latency and jitter. It also determines when the link goes online or offline.

The DMTS 103 is a decision-based engine that may be used to decide what transmission link to utilize in transmitting a data packet. The DMTS 103 may also control the enabling or disabling of FEC engine 105, such as when to send an FEC parity packet at any time in a given channel flow. In one embodiment the DMTS 103 may operate for the Tx direction. It determines for a given traffic, based on priority and other configured parameters like bandwidth cost, demand, which is the best link to send data packets over.

In one embodiment, the FEC layer lies between the DMTS 103 and the channel manager 107. The DMTS engine 103 controls when a FEC parity packet is sent for a given traffic flow. The FEC parity packet may be sent across multiple sub channels and the FEC 105 can be enabled/disabled for each traffic flow. If forward error correction is disabled for a given traffic flow, all packets for that traffic flow arriving from the DMTS engine 103 are just forwarded to the channel manager 107 without any FEC management.

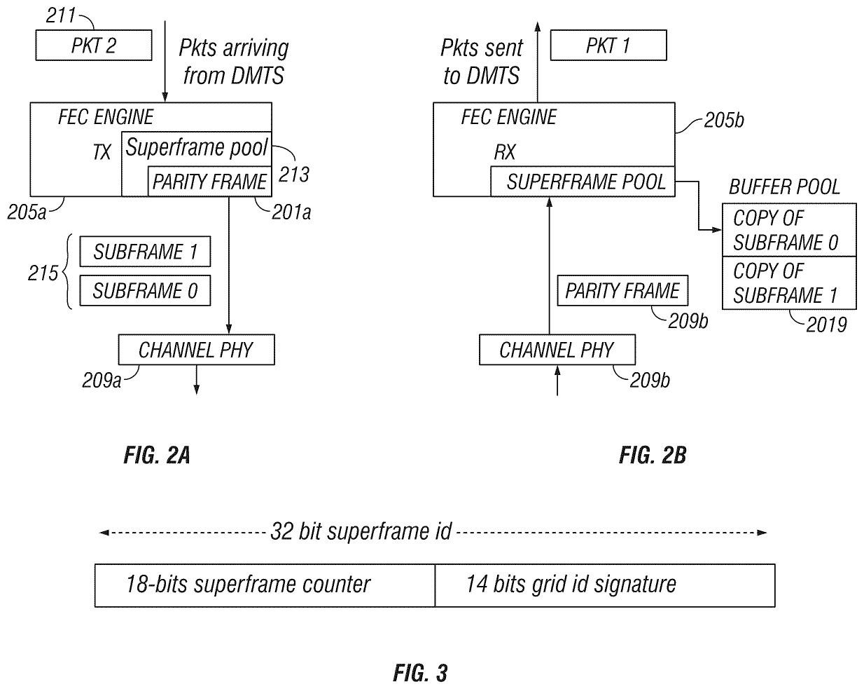

Referring to FIGS. 2A and 2B, visualization of FEC layer is shown with data flowing in the Tx direction (FIG. 2A) and the Rx direction (FIG. 2B). The Tx direction is responsible for generating the parity frame 201a, and the “Rx” direction, which is the part of the FEC engine that receives all data frames, including the parity frame 201b, and attempts to regenerate any lost frame. In one embodiment, the FEC engine supports generation of only one lost frame using a parity frame that is generated across N sub-frames. In one embodiment, if more than one data frame is lost, then the FEC engine will ignore regeneration of any lost frame.

In accordance with one embodiment, where the data packets are transmitted in the Tx direction through FEC engine 205a, packets 211 arriving from DMTS may go through a superframe pool 213 and are transformed into a plurality of subframes 215. Subframes 215 are XOR'ed to generate one parity frame 201a for each superframe pool 213. The DMTS determines after how many frames a parity frame is to be sent based on link conditions, for example, packet loss, jitter, and latency, which is what makes the FEC system adaptive or dynamic. Subframes 215 are then sent across to the channel side 209a to the other side (from Hub to Spoke, for example). The parity frame 201a is sent as the last frame after all subframes 215 are sent. The parity frame is a subframe of a superframe pool. A superframe pool has N data packets that are converted to subframes. All subframes have the same unique superframe pool ID to identify themselves as part of that pool.

In accordance with one embodiment, on the Rx side of the FEC 205b, subframes arriving from the channel side are transformed back to packets and sent to DMTS. A copy of each subframe is saved in a buffer pool for each superframe pool 217. Then the parity frame 201b may be used to generate any lost subframe like subframe 2, which is not stored in buffer pool because it was not received, as illustrated in FIGS. 2A and 2B. After all received subframes have been processed, pools are deleted and the superframe pool is freed.

### FEC Engine—Tx Side

In accordance with one embodiment, on the Tx side of the FEC engine 205a, packets 211 arriving from the DMTS Engine 103 are assigned to a pool referred herein as a superframe pool 213. The superframe pool 213 may be uniquely identified by a remote ID and a flow ID (Spoke and Hub are identified as “grid”). This information may be extracted from the packet frame itself.

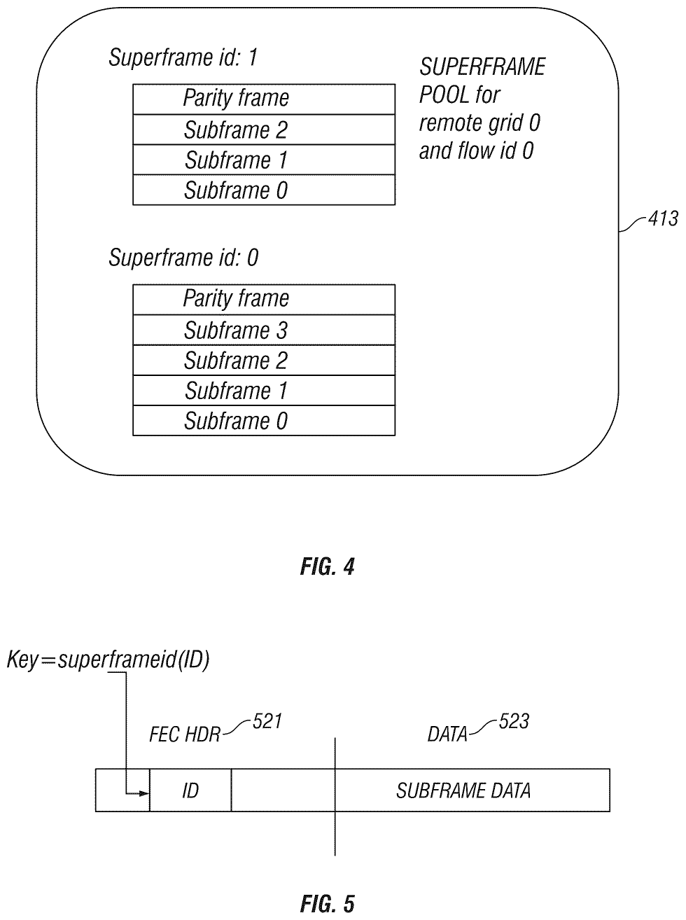

A superframe pool 413 is maintained for every Spoke to Hub connection. A given Spoke can connect to multiple Hubs and each such connection is identified by a unique remote grid ID. Similarly, a given Hub can also connect to multiple Spokes and same logic is applied (each such connection is identified by a unique remote grid ID). Thus, for each remote grid ID and unique traffic class/flow ID, the FEC engine maintains a superframe pool 413 (FIG. 4). This helps FEC engine to correctly tag the subframe with superframe ID on TX side and on the RX side also identify which grid it is coming from and save a copy in the correct superframe pool. Successive packets arriving for the same remote grid ID and flow ID are be assigned to the same superframe pool.

In one implementation, a hash table is maintained to save frames arriving from different grid IDs and flow IDs. Networking over satellite links is very dynamic and a frame can arrive at any given time. Thus, the system of the present invention maintains a pool to save frames arriving at different time frames for each grid ID and flow ID. As each frame arrives, the header is extracted to identify the gridID/flowID pool. Also, the FEC Engine extracts the superframe pool ID that indicates which superframe pool the subframe belongs to. A 1 second timer may be maintained for each grid ID and flow ID pool. If not all packets are received for a given pool, the timer kicks in and drops all the packets for a given pool. The parity frame header includes information about how many subframes are being sent as part of the superframe pool.

Once a packet is assigned to a superframe pool, it is referred as a subframe and is assigned a unique subframe ID. The FEC engine adds a 6-byte FEC header 521 to each subframe 523 before the subframe is sent to the channel manager (FIG. 5).

The FEC engine also maintains a parity frame for each superframe pool, the parity frame being generated by applying an XOR operation to N subframes. DMTS can indicate the parity frame to be sent any time thus making the system very flexible. For example, in one embodiment DMTS only operates in the TX direction. As DMTS is present on both Spoke and Hub, it gets input from the channel manager regarding the current link conditions and then sends the traffic class on the right link. On the RX side, the system just receives the packet and forwards it to drop side.

The ideal condition to avoid loss of frames is when a FEC parity frame is sent for every data packet frame sent over the link. In this manner, there is almost a 100% chance one can recover any lost frame without retransmission. However, that approach increase (maybe doubles) the bandwidth and is not recommended. Thus, based on link conditions like packet loss, latency and jitter, the DMTS determines after how many data packets should a parity frame be sent. In one embodiment, this variable may be set anywhere between 0 to 32 data packets. If the variable is set to 0, no parity frame is sent. If set to 4, then after every 4 data packets a parity frame is sent. Using this parity frame scheme, if one packet is lost over the link then the receive side can regenerate that frame using the parity frame. If more than 1 is lost then FEC Engine cannot do much and drops that pool and lets the upper layer do retransmission of lost packets.

If the DMTS does not indicate that a parity frame is to be sent and a maximum number of 32 subframes has been reached, for example, the FEC engine will automatically send the parity frame in accordance with one embodiment. The number of subframes can vary (i.e., can be other than 32 subframes).

The superframe pool has following properties:
Superframe ID
Subframe ID (more than one)
Parity frame
fec_level

The fec_level determines if FEC needs to be generated and sent for a given flow. It is set from a config file, meaning that it is configurable from a user interface (UI) where a user can disable FEC for a given traffic class. For example, if fec_level is set to “0 ”, then no parity is generated and sent for that flow.

### Superframe ID

Each superframe pool may use a unique superframe ID that it assigns to each subframe and parity frame. This is used on the RX side to generate any lost frame. In one implementation the system only allows one lost frame to be regenerated. The DMTS determines based on the current link condition how often to send a parity frame. If the link condition is poor, then a parity frame will be sent often, for example after every 4 or 5 data packets, but if the link condition is fair or improves, then a parity frame will be sent less often, for example after every 24 data packets or so.

In one embodiment, a Superframe ID may be defined as a 32-bit unsigned integer that is a combination of a unique counter and the remote grid ID. In one embodiment, out of 32 bits of the superframe ID, 18 bits may be assigned to the superframe counter and 14 bits may be derived from grid ID signature (FIG. 3).

The superframe counter helps to identify all the subframes belonging to a single set for which a parity frame has been generated. Once the parity frame is sent, the superframe counter is incremented to identify the next batch of subframes for which a parity frame will be generated. The grid ID is used to identify the sender's uniqueness, so that two subframes arriving from different grid IDs do not land in the same pool on the receive side.

### Subframe ID

The subframe ID may be defined as a 5-bit counter that uniquely identifies each subframe within a superframe pool. The subframe ID is incremented for every new subframe that arrives at the FEC engine from DMTS. In one embodiment, there is a maximum 32 sub frames for a given superframe ID, which means that for a particular superframe ID, there is one parity frame and subframes 0-31. In one embodiment, if a parity frame is not sent by the 32nd subframe, the FEC engine will automatically send the parity frame after the 32nd subframe and reset the subframe ID to 0 for the next batch corresponding to a superframe ID. The combination of superframe ID and subframe ID helps the receive side of the FEC engine to regenerate any lost frame as described below.

### Data Subframe

A packet arriving at the FEC engine from the DMTS engine is assigned to a superframe pool and is converted to a subframe by the FEC engine adding a 6-byte header to the data packet (the entire data packet is encapsulated in the subframe with addition of the header and that is the extent of the processing of the received data packet) as shown below:

| | |
|---|---|
| 6 byte FEC HDR | Data part of subframe |

| | | | |
|---|---|---|---|
| GCM Header | Rsvd: | Subframe | Superframe |
| Id: 8 bits | 3 bits | ID: 5 bits | ID: 32 bits |

GCM header has two parts to it, the header ID and the message ID:

HDR ID: 4 bits, value=GCM_FEC: 1

MSG ID: 4bits, value=GCM_FEC_DATA: 1

The GCM may be defined as the grid header that is added by each layer. To uniquely identify each layer, the header includes header ID and msg ID. Message ID for FEC is either a parity frame or a data frame for the RX side to determine what type of frame it is.

The subframe ID and the superframe ID are assigned from the superframe pool as discussed above. The 3 bits in the subframe header are reserved for future use in accordance with one embodiment.

### Parity Frame

For every new packet that arrives from the DMTS engine, the FEC engine generates a subframe, as discussed above, and the FEC engine applies an XOR operation to the subframe data with respect to previous subframes data and create the parity frame. In one embodiment the parity frame is uniquely created for each superframe pool.

In one embodiment the FEC engine adds an 8-byte parity header for each parity frame as shown below:

| | |
|---|---|
| 8 byte FEC HDR | XOR'ed DATA OF PARITY FRAME |

In one embodiment the 8-byte FEC header contains the following information:

ID:32

| | | | |
|---|---|---|---|
| GCM Header | Total subframe | Total subframe | Superframe |
| ID: 8 bits | len: 19 bits | XOR'ed: 5 bits | ID: 32 bits |

In one embodiment the GCM header has two parts to it, the header ID and the message ID:

HDR ID: 4 bits, value=GCM_FEC: 1

MSG ID: 4bits, value=GCM_FEC_PARITY: 2

The superframe ID is assigned from the superframe pool and gets used at the receive side of the FEC engine. The total subframe len is the total bytes of all subframe data length added together that has been used to generate the XOR data of the parity frame, and the total subframes is the total number of subframes that have been XOR'ed to generate the parity frame. Both total length and total subframes are used on receive side of FEC engine to regenerate any lost subframe.

### FEC Engine—Rx Side

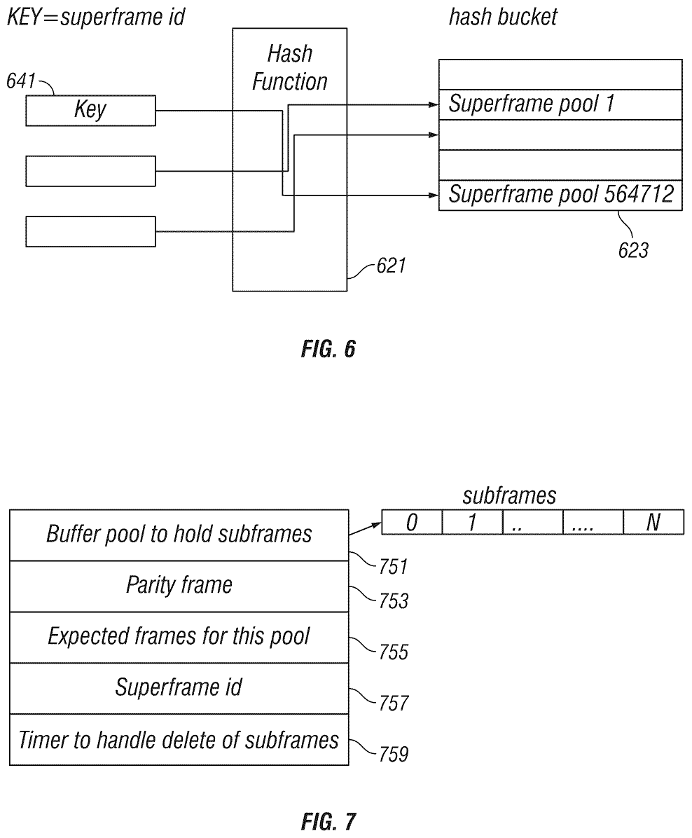

In one embodiment, the main functionality of receive side (Rx) of the FEC engine is buffer management and regeneration of any lost frames. The FEC engine may save all subframes received for a given set of superframe ID until it knows all subframes have arrived (the parity frame includes that information). Each frame arriving at the FEC engine from the channel side is checked to see if it is parity frame or a data frame, which can be ascertained from the FEC header added to the frame because it indicates whether it is a parity frame or a data frame. If the frame received is a data frame then a copy of the subframe is created and the original subframe is sent to the DMTS engine to avoid any delays. From the copy of the data subframe, header information is extracted to see which superframe ID it corresponds to. Referring to FIG. 6, that superframe ID is then used as key 641 to search a hash table 621 to get the superframe pool 623.

### Rx Superframe Pool

In one embodiment, the FEC engine maintains a superframe pool for each unique superframe ID (FIG. 5). Superframe ID is extracted from the subframe header for a given data frame. The superframe pool 623 may be accessed through a hash table 621 as illustrated in FIG. 6. The information contained in the superframe pool is shown in FIG. 7.

### FEC Algorithm

In one embodiment, if no superframe pool is found for a given key then a new superframe pool is created and saved in the hash bucket (623, FIG. 6). If a subframe received by the FEC engine from the channel is the first subframe for a given superframe ID, then the FEC engine will create a new buffer pool and save this data subframe in the pool for later use.

Referring to FIG. 7, for all successive data frames that arrive from the channel for a given superframe ID 757, the FEC engine will save a copy of that subframe in the buffer pool. At this point the FEC engine does not know how many subframes correspond to a given superframe ID, as it has to wait to receive a parity frame. As soon as parity frame 751 is received by the FEC engine, the FEC engine checks if all subframes have arrived 755.

In one embodiment, if there are N−1 subframes received by the FEC engine, then the FEC engine will regenerate a single lost frame in that pool and send it to the drop side. If more than 1 subframe is lost then the FEC Engine will discard that pool. Once all subframes are received by the FEC engine, the FEC engine deletes all subframes 759, frees up the buffer pool, deletes the superframe pool, and deletes the corresponding entry from the hash table.

If a parity frame arrives before N−1 subframes then the FEC engine stores the parity frame so that a decision can be made later as to whether to regenerate any lost frames. If any subframes arrive after a corresponding parity frame has been received, the FEC engine will then know the expected frames for that pool and will regenerate the last frame as soon as the N−1 frame arrives without waiting for the last frame to arrive. If the last frame arrives after it is regenerated, then the real frame will be discarded and not forwarded to the DMTS engine. The logic here is if the FEC Engine receives N−1 subframes and a parity frame, then instead of waiting for 1 second timer to expire, it will regenerate the last subframe it is supposed to receive. Thus, if a pool contains 4 subframes and 1 parity frame and it receives 1,3,4 and parity frame on Rx side then instead of waiting for 2nd subframe to arrive it will regenerate that frame instead of waiting for 1 second timer to expire.

In one embodiment, as soon as the first subframe arrives at the FEC engine, the FEC engine starts a timer for 200 milliseconds, which will be pushed for another 200 millisecond when the next subframe arrives. If no subframe is received by the FEC engine within the 200 millisecond limit, then the timer expires. Once the timer expires all subframes are deleted and the timer will enter in a DISCARD_STATE state of 1 second. If any subframe arrives after the timer goes into the DISCARD_STATE state, then no copy of the subframe will be added to the buffer pool and the received subframe will be discarded. After the DISCARD_STATE timer expires a cleanup operation will occur and the buffer pool will be deleted.

### Exemplary Implementations

In all of the following exemplary implementations of how the FEC engine works, a parity frame is generated for three subframes.

### First Exemplary Implementation: FEC Parity Frame is Received after all 3 Subframes are Received for Superframe ID 1

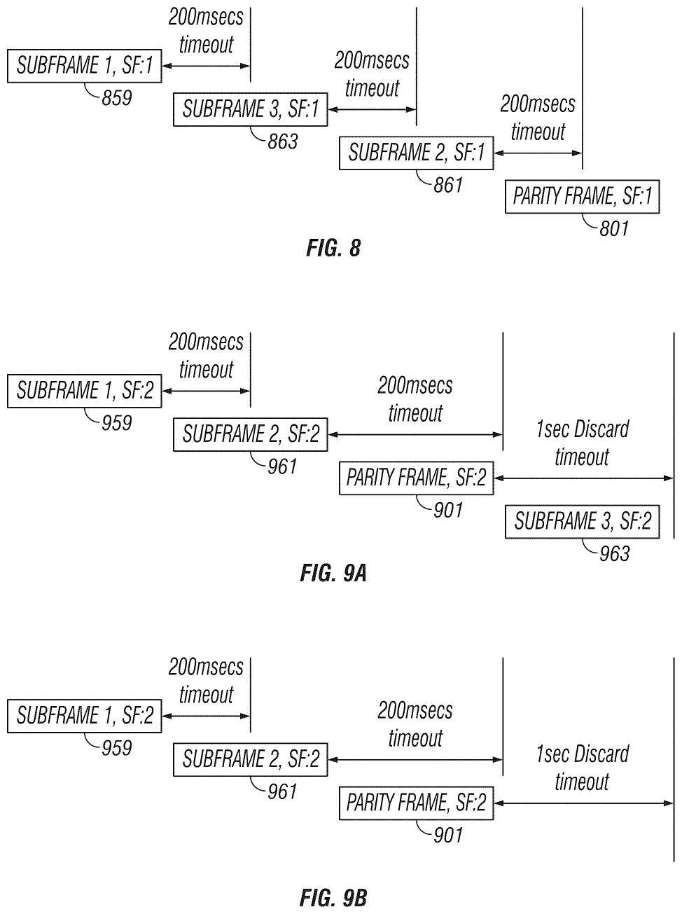

In the implementation illustrated in FIG. 8, all 3 subframes (859-863) and parity frame 801 for superframe ID 1 arrive in sequence. A copy of each subframe is saved in the buffer pool for the given superframe ID: 1 in the superframe pool. A timer which is part of FEC engine of 200 millisecond is started once the first subframe arrives and keeps extending as new subframes arrive. After the parity frame arrives, the FEC engine knows the total frames corresponding to the superframe (from the parity frame, the FEC Engine will determine the superframe pool it belongs to as that information is derived from the parity frame header) being processed and as all frames have arrived the FEC engine cleans up as follows:
Stop timer
Delete all subframes
Delete buffer pool memory
Remove superframe pool entry from hash table
Delete superframe pool for superframe ID 1

### Second Exemplary Implementation: FEC Parity Frame is Received after N−1 Subframes are Received for Superframe ID 2

In the implementation illustrated in FIGS. 9A-B, the algorithm works as follows:
1. First 2 subframes (959 and 961) and parity frame for superframe ID 2 arrive in sequence.
2. A copy of each subframe is saved in buffer pool for the given superframe id: 2 in superframe pool.
3. A timer of 200 milliseconds is started once the first subframe arrives and keeps extending as new subframes arrive.
4. After parity frame arrives, FEC engine figures out that it is missing one subframe so it goes and generates the missing subframe 3 (963).
5. A cleanup operation is implemented after parity frame arrives as follows:
   a. Stop timer
   b. Delete all subframes
   c. Delete buffer pool memory
   d. Start a 1 sec DISCARD TIME_WAIT timeout to discard subframe 3 if it arrives late.
6. In the implementation illustrated in FIG. 9A, subframe 3 arrives late so it is discarded and not sent to DMTS as the FEC engine knows it has already regenerated the frame.
7. In the implementation illustrated in FIG. 9B, if subframe 3 never arrives, then that scenario is acceptable as the FEC engine has already regenerated the frame and sent it to DMTS.
8. Once the DISCARD TIME_WAIT timer expires the following cleanup process is implemented:
   a. Remove superframe pool entry from hash table
   b. Delete superframe pool for superframe ID 1

### Third Exemplary Implementation: FEC Parity Frame is Received Before N−1 Subframes are Received for Superframe ID 3

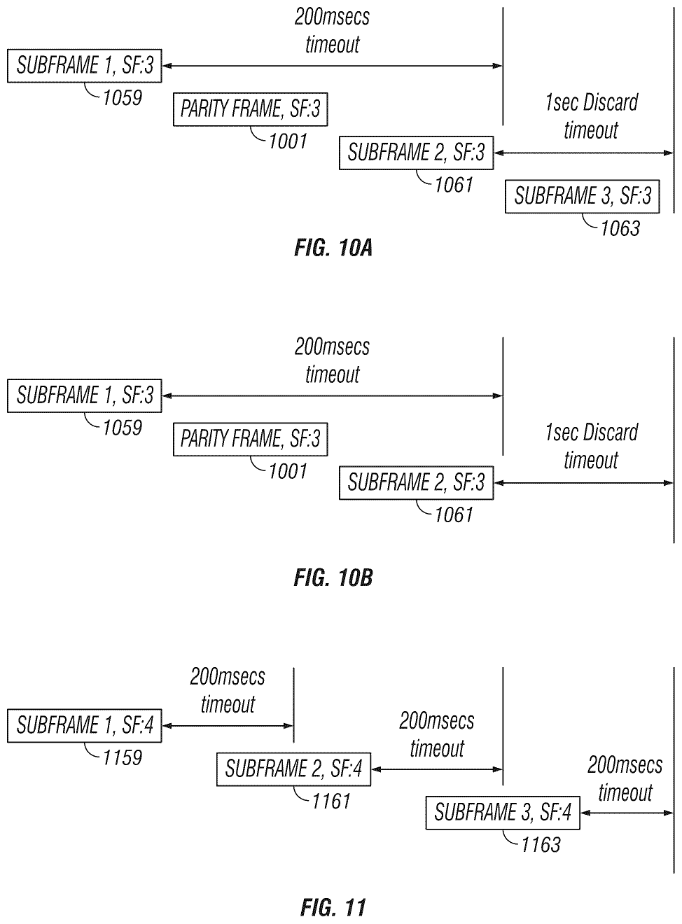

In the implementation illustrated in FIGS. 10A-B, the algorithm works as follows:
1. Parity frame 1001 for superframe ID 3 arrives before the last 2 subframes arrive.
2. A timer of 200 milliseconds is started once the first subframe (1001 and 1063) arrives (FIG. 10A).
3. After parity frame arrives, FEC engine figures out that it is missing more than 1 subframe so it has to wait for more subframes to arrive.
4. The FEC engine saves the parity frame and waits for more subframes to arrive.
5. Now that the FEC engine knows how many frames are expected (extracted from parity frame header), it will also update the expected_frame field in the superframe_pool.
6. As new subframe arrives, the FEC engine will check if it has received N−1 subframes. If not, then it will keep adding the subframes in buffer pool and extend the 200-millisecond timer. The logic here is that the FEC engine may always check if it has received all N subframes. If not, it checks if it has at least received N−1 subframes and parity frame so that it can generate the lost subframe.
7. Once it receives N−1 frames it will regenerate the last subframe and implement a cleanup operation as follows:
   a. Stop timer
   b. Delete all subframes
   c. Delete buffer pool memory
   d. Start a 1 sec DISCARD TIME_WAIT timeout to discard subframe 3 if it arrives late (FIG. 10B).

### Fourth Exemplary Implementation: FEC Parity Frame is not Received for Superframe ID 4

In the implementation illustrated in FIG. 11, the algorithm works as follows:
1. Parity frame for superframe ID 4 is never received.
2. In this case the 200 millisecond timeout expires and as parity frame is never received, the FEC engine has no way of ascertaining if there are any lost frames.
3. Cleanup in this exemplary implementation occurs inside timer expiration routine:
   a. Delete all subframes (1159-1163)
   b. Delete buffer pool memory
   c. Start a 1 sec DISCARD TIME_WAIT timeout to discard any late arrival frames
4. If parity arrives late it will simply be discarded and FEC engine waits for 1 sec timer expiration.
5. If parity frame never arrives then then 1 sec timer expires and that copy of all subframes are removed and the pool is cleaned up.
6. Once DISCARD TIME_WAIT timer expires the following cleanup operation is implemented:
   a. Remove superframe pool entry from hash table
   b. Delete superframe pool for superframe ID 1

### Fifth Exemplary Implementation: Lost Subframes and/or Parity Frame for Superframe ID 5

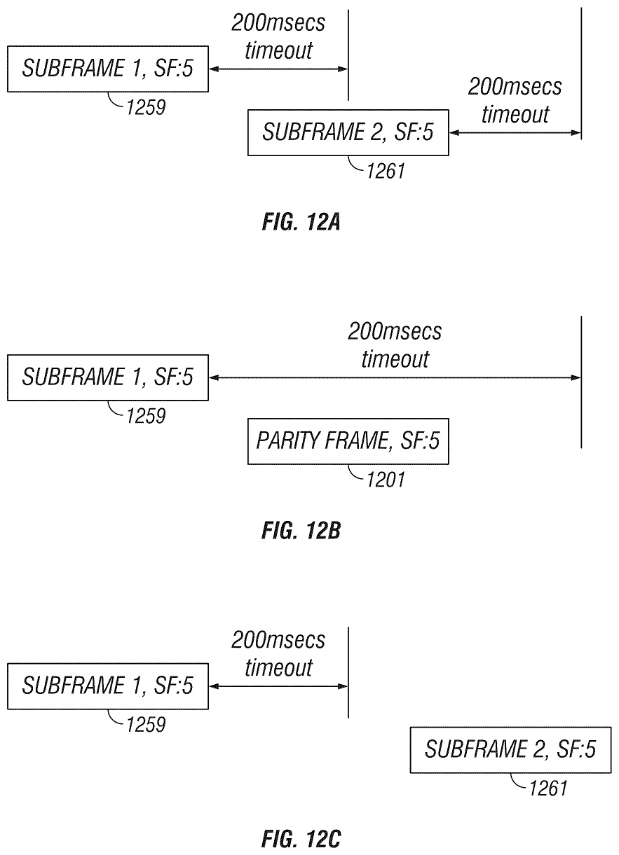

In the implementations illustrated in FIGS. 12A-C, more than 1 subframe is lost (FIG. 12B) or 1 subframe and also the parity frame is lost (FIG. 12A and FIG. 12C). In all these cases, the FEC engine really cannot do much and will wait for timer to expire. Once the timer expires, a cleanup operation occurs inside timer expiration routine:
a. Delete all subframes
b. Delete buffer pool memory
c. Start a 1 sec DISCARD TIME_WAIT timeout to discard any late arrival frames.

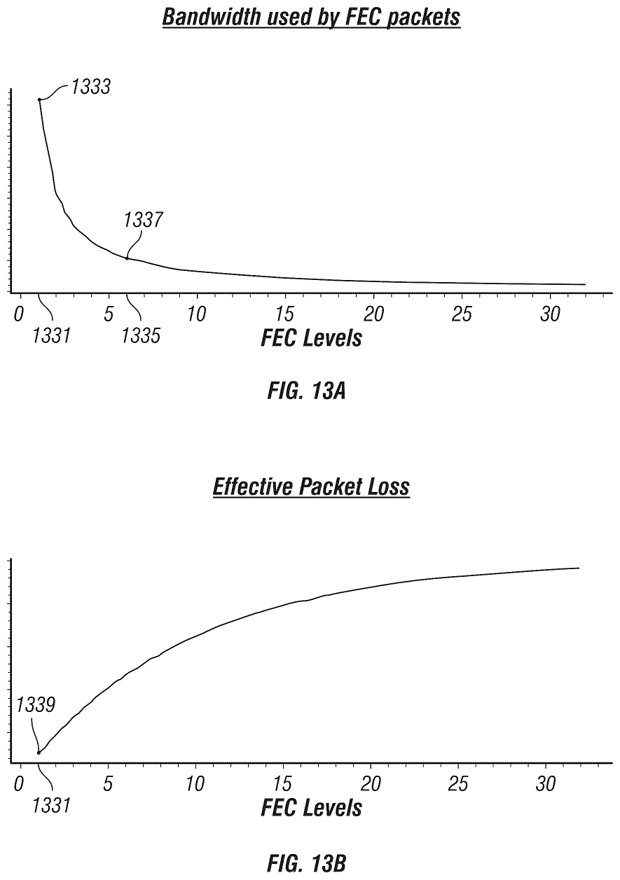

FIG. 13A illustrates the relationship between FEC level (x-axis) and consumed bandwidth (y-axis) and FIG. 13B illustrates the relationship between FEC level (x-axis) and packet loss after implementing FEC (y-axis) in accordance with one embodiment. With reference to FIGS. 13A-B the term “FEC level” refers to the number of packets that are XORed to generate a parity check packet. For example, for an FEC level 1 (1331), which means that for each data packet to be transmitted a parity check is also sent, the network bandwidth required would be high (1333, see FIG. 13A) whereas if the FEC level is increased to 6 (1335), then the bandwidth required would start to sharply decline (1337, see FIG. 13A). This does not mean necessarily that at all times a FEC level 6 would be chosen as a set parameter, since the FEC level selected is a tradeoff between bandwidth and link conditions, such as packet loss and latency. For example, for a FEC level of 1 there would be no significant packet loss (1339, see FIG. 13B) but then the end user would experience a slow network connection as roughly 50% of the network bandwidth would be used for transmitting parity checks.

The frequency at which the DMTS determines the FEC level is set at every second. This approach is adopted to accommodate scenarios where sudden traffic bursts occur, as it is desirable to avoid compromising other types of traffic by potentially eliminating the use of any FEC level altogether.

A packet loss rate of 4.7% and 26.5% does not result in a direct transformation from 4.7% to 26.5% through the application of FEC. In reality, if a given FEC level is set to 6, it may improve a link with a 10% packet loss to 4.7%, and a link with a 30% packet loss to 26.5%. Thus, the higher the packet loss, the lower the FEC level required. Lower FEC levels result in higher bandwidth consumption, creating a trade-off, as discussed above. The DMTS engine effectively addresses this trade-off by considering traffic type priorities, packet loss thresholds, and real-time demands.

In some implementations a non-transitory, computer-readable medium may contain instructions that when executed by the processor cause the processor to perform any of the methods described herein, including the methods performed by the DMTS engine or module, FEC engine or module, or the channel manager engine or module. Alternatively the DMTS, FEC and/or the channel manager may be implemented in pure hardware configurations or a combination of both.

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A communication system comprising:
a Dynamic Multiple Input/Multiple Output Transmission System (DMTS) module; and
an adaptive forward error correction (FEC) module including,
a transmission module for receiving first packets and commands from the DMTS module, generating a parity check for n number of said first packets, and retransmitting said first packets with the parity check to a channel manager in a transmission direction, and further including
a receive module for receiving second packets from the channel manager in a receive direction;
wherein
the DMTS controls when a parity check is sent for a traffic flow;
the parity check may be sent across multiple channels; and
the FEC module can be enabled or disabled for each traffic flow.

2. The system of claim 2, wherein the channel manager switches between subchannels between the FEC module and a channel side.

3. The system of claim 3, wherein the channel manager determines link conditions for a link, including packet loss, latency and jitter, and wherein the channel manager further determines when the link goes online or offline.

4. The system of claim 1, wherein the DMTS module selects a transmission link to utilize in transmitting a data packet, controls the enabling or disabling of the FEC module, including when to generate and send said parity check at any time in a given channel flow.

5. The system of claim 4, wherein the DMTS operates in a transmission direction to determine for a given traffic, based on traffic priority, jitter, latency, packet loss, bandwidth cost, or demand, from a number of available links which is the best link to send data packets, how often a parity check is to be sent by the transmission module of the FEC module, and the number of N packets for which the parity check is generated.

6. The system of claim 1, wherein the receive module of the FEC module receives the second data packets, the second data packets including a parity check, and processes the second data packets to regenerate any lost packets.

7. The system of claim 6, wherein the receive module regenerates one lost data packet.

8. The system of claim 6, wherein the receive module does not regenerate any lost data packets when more than one data packet is lost.

9. The system of claim 1, wherein said first data packets are transmitted in the transmission direction through the transmission module of the FEC module, the transmission module assigns one or more of said first data packets to a superframe pool having a plurality of subframes; wherein said subframes are XOR'ed to generate one parity frame for each superframe pool.

10. The system of claim 9, wherein the parity check is added as a subframe to said superframe pool.

11. The system of claim 10, wherein said subframes are sent across to a channel side through the channel manager and said parity check subframe is sent as the last frame after all subframes are sent.

12. The system of claim 9, wherein said second data packets are received by the receive module of the FEC module as subframes arriving from the channel manager, are transformed to packets, and sent to the DMTS module.

13. The system of claim 12, wherein the receive module of the FEC module stores a copy of each subframe in a buffer pool for each superframe pool and the parity check is used to generate any lost subframe.

14. The system of claim 13, wherein after all received subframes are processed by the receive module of the FEC module, pools are deleted and the superframe pool is freed.
